(19) United States
(12) Patent Application Publication
(10) Pub. No.: US 2022/0118941 A1
(43) Pub. Date: Apr. 21, 2022

(54) Systems And Methods For Vehicle Movement Parental Control With Child Detection

(71) Applicant: Ford Global Technologies, LLC, Dearborn, MI (US)

(72) Inventors: Cynthia M. Neubecker, Westland, MI (US); Robert Parenti, Dearborn, MI (US); Brad Ignaczak, Canton, MI (US)

(73) Assignee: Ford Global Technologies, LLC, Dearborn, MI (US)

(21) Appl. No.: 17/075,165

(22) Filed: Oct. 20, 2020

(51) Int. Cl. B60R 25/042; G08B 21/24; G08B 21/22; G08B 21/02; G06K 9/00

(52) U.S. Cl. CPC B60R 25/042; G08B 21/24; G08B 21/22; B60R 2325/205; G06K 9/00838; G06K 9/00228; G08B 21/0202

(57) ABSTRACT

Vehicle movement parental control with child detection systems and methods are disclosed herein. An example method can include determining presence of a known child in a vehicle, activating a drive lock mode of the vehicle to prevent the vehicle from being driven based on the presence of the known child, providing a request for authorization to allow the vehicle to be driven, and continuing or disabling use of the drive lock mode of the vehicle based upon a response to the request for authorization.

### BACKGROUND

A scenario may exist where a child is inside an idle vehicle or enters a vehicle and the vehicle drives away without the parent or guardian's consent. A child could be abducted intentionally, or unintentionally, when a malicious actor steals a vehicle. A child could also enter a vehicle unbeknownst to the driver of the vehicle.

### BRIEF DESCRIPTION OF THE DRAWINGS

The detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 is a flowchart of an example method of the present disclosure that pertains to implementing a vehicle parental control feature.

FIG. 3 is a flowchart of an example of the present disclosure related to vehicle parental control features where a drive lock mode is activated and/or deactivated.

FIG. 4 is a flowchart of another example of the present disclosure related to vehicle parental control features where a drive lock mode is activated and/or deactivated.

FIG. 5 is a flowchart of another method of the present disclosure that includes vehicle tracking and remote disabling.

### DETAILED DESCRIPTION

### Overview

The present disclosure generally pertains to systems and methods for enabling vehicle movement parental control with child detection features. Systems and methods disclosed herein pertain to solutions that utilize vehicle sensing technology, such as face identification or voice recognition, to detect if a known child may be entering a vehicle or may already be inside the vehicle. Once the detection system determines that a known child present in the vehicle, a drive lock mode can prevent the vehicle from being driven away without explicit authorization from an authorized user, such as a parent or vehicle owner.

The vehicle can be configured to record turn-by-turn directions of the vehicle when the vehicle is being driven (by an authorized or even an unauthorized party) and make these turn-by-turn directions available to the parent or guardian as needed. One example involves transmitting GPS signals and converting the GPS signals into turn-by-turn directions using an application executing on their mobile device.

In general, cameras or arrangements of light and/or imaging sensing systems present can be used to detect and authenticate users such as children and drivers. These cameras may be located inside or outside the vehicle. Example methods can be used to detect and identify a minor ingressing a vehicle or already inside a vehicle using, for example, image-based facial recognition.

Example methods may alert parents or guardians of minor status and vehicle status. This alert may be provided through an application on a smartphone or wearable or via a vehicle user interface such as a human-machine interface (HMI). In some instances, a service provider can utilize cloud relevant data in support of the systems and methods herein.

In some instances, a vehicle computer can implement one or more algorithms to analyze data and make situational assessments (e.g. whether or not guardian authorization is needed). A vehicle user interface can be implemented to allow a guardian to provide authorization and deactivation of a drive lock mode. The systems and methods can specify a vehicle interface to a cloud service provider, enabling guardian authorization from a smartphone or wearable device.

### Illustrative Embodiments

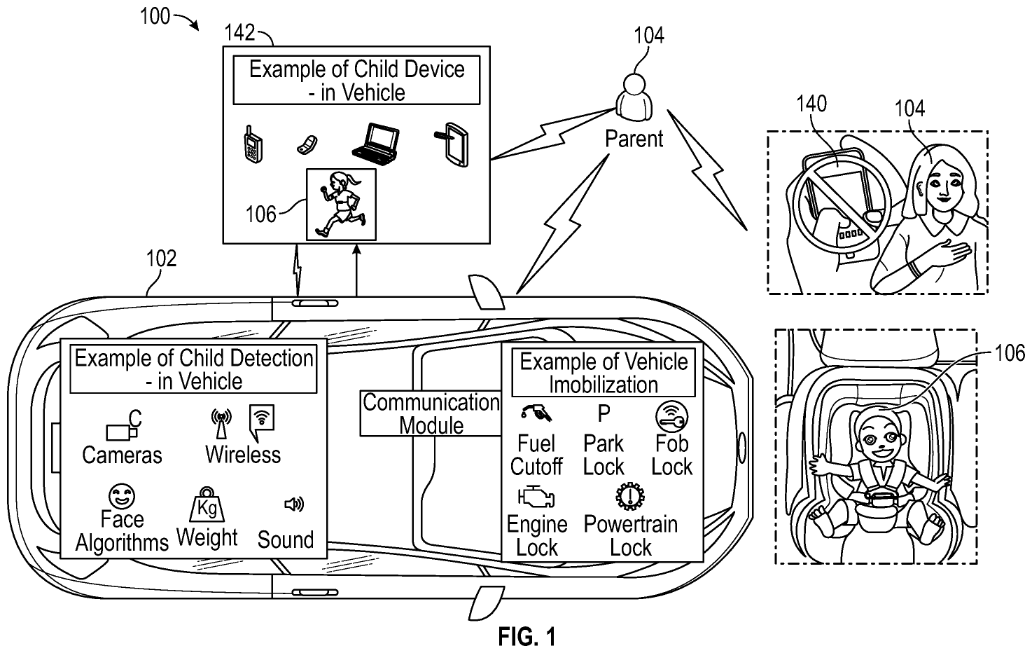

Turning now to the drawings, FIG. 1 depicts an illustrative architecture 100 in which techniques and structures of the present disclosure may be implemented. The architecture 100 can include vehicle 102, a first user 104, a second user 106 (referred to as a known child, or child), a service provider 108 and a network 110. The network 110 may include any one or a combination of multiple different types of networks, such as cable networks, the Internet, cellular networks, wireless networks, and other private and/or public networks. In some instances, the network 110 may include cellular, Wi-Fi, or Wi-Fi direct. In other embodiments, components of the environment can communicate using short-range wireless protocols such as Bluetooth®, near-field communications, infrared, and the like.

The vehicle 102 can comprise a vehicle computer 112, an image sensing platform 114, a telematics control unit (TCU 116), one or more seat sensors 118, and one or more microphones 120. The vehicle 102 can also comprise various interruptible systems or assemblies. Interruption of one or more of these systems or assemblies may be effectuated as a part of a drive lock mode for the vehicle, as discussed in greater detail infra. For example, the vehicle 102 can comprise a fuel system 122, a parking brake 124, one or more door locks 126, an engine lock 128, a powertrain lock 130, and/or a steering wheel lock. Generally, the fuel system 122 can be electronically controlled by the vehicle computer 112 to turn on and shut off fuel to an engine of the vehicle 102 when a drive lock mode is active. The parking brake 124 can be electronically controlled by the vehicle computer 112 to activate and deactivate to control the rotation of the wheels of the vehicle 102 when a drive lock mode is active. The one or more door locks 126 can be electronically controlled by the vehicle computer 112 to lock or unlock the door(s) of the vehicle 102 when a drive lock mode is active. The engine lock 128 and the powertrain lock 130 can also be electronically controlled by the vehicle computer 112 to shut down the engine of the vehicle, or prevent power transfer through the powertrain lock 130, respectively when a drive lock mode is active. Similarly, the steering wheel lock can be controlled to lock the steering wheel.

The vehicle computer 112 can comprise a processor 132 and memory 134. The memory 134 stores instructions that can be executed by the processor 132 to perform any of the vehicle occupancy detection and parental control features, which can include drive lock mode activation and deactivation. The vehicle computer 112 can utilize vehicle sensing technology that can include face or voice identification, to detect if a known child is ingressing a vehicle or is already inside the vehicle. Once the vehicle computer 112 identifies a known child in the vehicle, the vehicle computer 112 requests or receives drive lock mode to enable the vehicle to be driven away. In one example, the vehicle computer 112 can be configured to use these methods to prevent criminals or unwitting users from driving away in a vehicle with a minor inside. For example, the systems and methods can be utilized to prevent an unauthorized user from driving away in an unattended vehicle. As noted above, some passengers may be children. A child may be referred to as a known child when the child has a profile stored at the vehicle or service provider level.

Such authorization may be provided within the vehicle through an HMI 138 or remotely through a smartphone 140 (e.g., mobile device) or a similar device. Additionally, the vehicle computer 112 may record the drive turn-by-turn and make it available to the parent or guardian as needed, such as through the smartphone 140. For example, the vehicle computer 112 can obtain GPS information from the TCU 116 and generate turn-by-turn directions that are indicative of the path of travel of the vehicle over time. This information can be provided in real-time or near-real-time to the smartphone 140 of the user.

The vehicle computer 112 can be configured to communicate over the network 110 with any of the components of the architecture such as the service provider 108. The vehicle computer 112 can incorporate or use any known communication device to transmit and/or receive data over the network 110. When referencing operations performed by the vehicle computer 112, it will be understood that this includes the execution of instructions stored in the memory 134 by the processor 132.

In one example use case, the vehicle computer 112 can be configured to activate a parental control feature that includes a surveillance mode for determining the presence of a known child in the vehicle 102. The parental control feature, when active, may survey the vehicle for users present in the vehicle 102 such as passengers and/or drivers. This can occur through image analysis, audio analysis, or device presence, as discussed in greater detail infra.

In more detail, the vehicle computer 112 can store a profile for each child that is known to travel in the vehicle. A parent can cause the creation of a profile for each of their children that ride in the vehicle. The profile can include information such as facial images of the child that can be used in facial recognition processes discussed herein. The profile can also include other information such as height, weight, and other user metrics that can be utilized to determine the presence of the child in the vehicle. Child information, such as the profile can be stored locally at the vehicle 102, such as in the memory 134 of the vehicle. The profile can be stored at the service provider 108 in some instances.

In some instances, profiles for each user of the vehicle 102, such as drivers and passengers, can be stored at the vehicle level or the service provider 108. Profiles can be stored for drivers so the vehicle computer 112 can determine if a driver present in the vehicle is an authorized driver. When an unauthorized driver is sensed, the vehicle computer 112 can place the vehicle in an active drive lock mode to prevent the vehicle 102 from being driven. Alternatively, if an unauthorized user somehow gains access to the vehicle and begins driving the vehicle, the vehicle computer 112 can place the vehicle active drive lock mode based on a command received from an authorized user.

For example, when a child enters the vehicle 102, the vehicle computer 112 can obtain images from the image sensing platform 114. Generally, the image sensing platform 114 can include one or more cameras that obtain images of users in the vehicle. These images can be compared to images stored in the profiles for the vehicle. When a known child enters the vehicle, the vehicle 102 can be placed into a drive lock mode where control of the vehicle is disabled. That is, the vehicle 102 can be rendered immobile.

The known child could also be identified through detection of a child electronic device 142 in the vehicle. Various examples of child electronic devices are illustrated in FIG. 1. The child electronic device 142 could include a laptop, a smartphone, a wearable device (such as a smartwatch), or other similar electronic device. The vehicle computer 112 could sense the presence of the child electronic device 142 in the vehicle through a short-range wireless connection, such as Bluetooth® or Wi-Fi. That is, the child electronic device 142 may pair with the vehicle computer 112 or another vehicle system when the child electronic device 142 is located in close proximity to the vehicle 102. The vehicle computer 112 may be configured to place the vehicle in a drive lock mode when presence of the child electronic device 142 is determined.

In some instances, the output of the one or more seat sensors 118 can be used to determine or infer a location of a child in the vehicle. For example, the one or more seat sensors 118 could include pressure sensors that detect weight of a user. When the weight is indicative of a child (e.g., less than one hundred pounds for example), the vehicle computer 112 can utilize this information to infer that a child is present in the vehicle. Seat pressure sensor information can also be used to identify which cameras of the image sensing platform should be activated by the vehicle computer 112.

In yet other instances, the presence of a child can be determined from evaluating audio information obtained from the one or more microphones 120. That is, audio signals in the cabin of the vehicle 102 can be obtained by the one or more microphones 120 and subsequently analyzed by the vehicle computer 112. When an audio signal includes vocal attributes that correspond generally to a child or even corresponds to an audio profile of a known child, the drive lock mode can be activated. The vocal attributes could include a pitch or tone, or words/phrases as an example. For example, vocal attributes could indicate that a baby or toddler is present.

To be sure, while some embodiments disclosed herein can be used to detect a known child in a vehicle and activate a drive lock mode in response, the present disclosure is not so limited. The present disclosure can be used to generally detect the presence of any child in a vehicle and activate a drive lock mode in response. This could include using pattern recognition to detect a child through height or face shape. Alternatively, this could include using seat pressure sensor information, as another example. In another example, audio signals could indicate that a child is present or likely to be present in the vehicle. The generic detection of child presence in a vehicle may alleviate situations where a child unknowingly enters a vehicle. The systems and methods disclosed herein can prevent the vehicle from being driven away with an unidentified child present. In these instances, the driver could be asked to scan the vehicle for the presence of a child.

In one example, the drive lock mode can be deactivated through a request and response process. For example, the vehicle computer 112 can cause the display of a request message on the HMI 138. In one example, the request could include a user interface that receives a code. The code could be a dedicated secret code known to an authorized party. The code could also be a one-time use code transmitted to the smartphone 140 of the authorized party. An authorized user can provide another designated driver the one time use code, and this designated driver could enter the code into the HMI 138. The vehicle computer 112 can also utilize facial recognition to confirm an identity of the authorized user that entered the code. The vehicle 102 could also comprise a biometric information reader such as a fingerprint scanner. The request and response process could include receiving biometric information from a user, as well as authorization through comparing the received biometric information to stored biometric information residing at the vehicle level or the service provider 108. The biometric information reader can be integrated into the HMI 138 of the vehicle 102. In yet other instances, the request and response process could be effectuated through natural language processing where requests are output as audio from the HMI 138 and responses are received through the one or more microphones 120. The vehicle computer 112 can be enabled with natural language processing capabilities. Alternatively, the vehicle computer 112 can utilize natural language processing enabled at the service provider 108. It will be understood that any of the request and response procedures disclosed herein can be enabled through cooperative action between the vehicle computer 112 and the service provider 108.

Rather than using the HMI 138, the vehicle computer 112 can allow an authorized user to activate or deactivate the drive lock mode from their smartphone 140. For example, the vehicle computer 112 can transmit a request to the smartphone 140. An application executing on the smartphone 140 can receive and display the request to the authorized user. The authorized user can respond to the request with authorization information such as a code, biometric information, or the like.

The drive lock mode can be disabled upon receiving authorization from an authorized user. For example, an authorized user can transmit a request to disable the vehicle 102 from their smartphone 140. This process can be facilitated through a service provider in some instances.

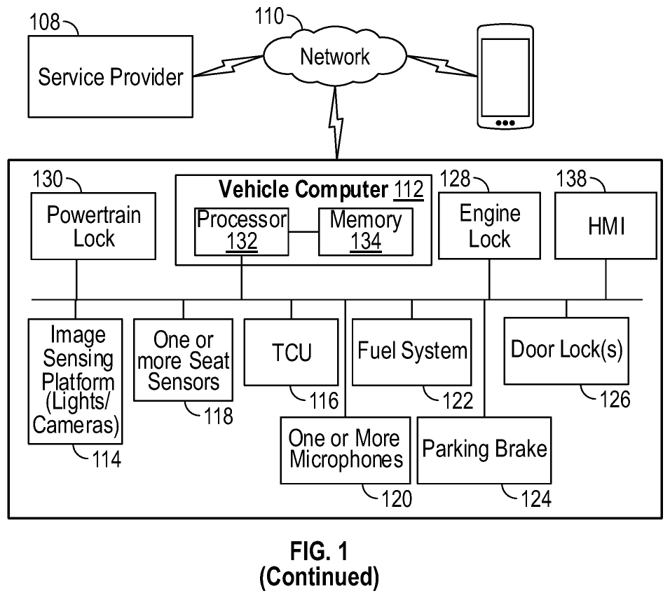

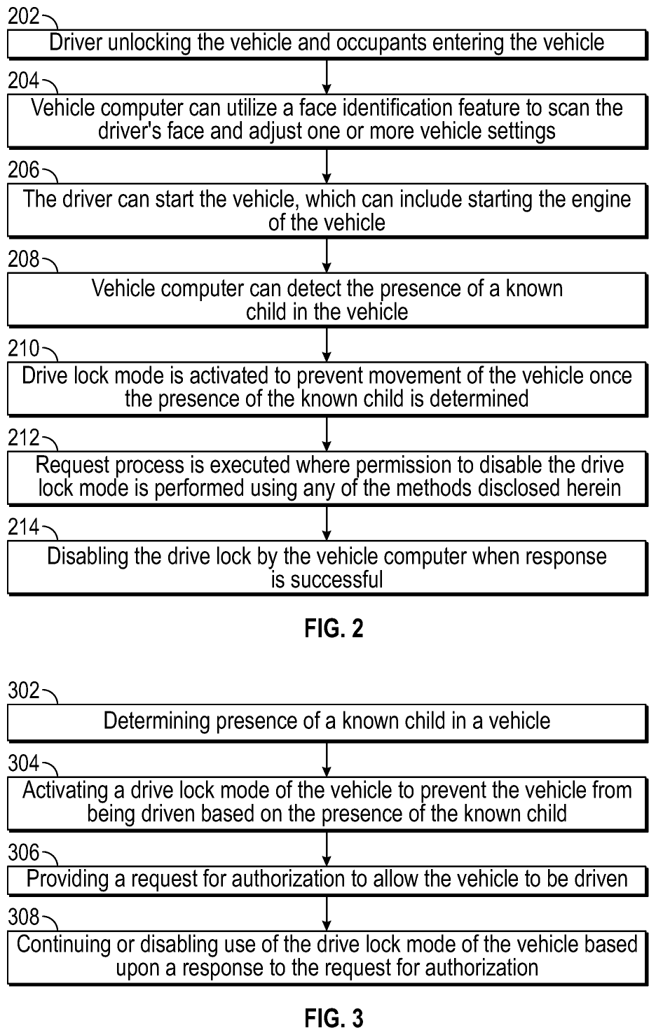

FIG. 2 illustrates an example method of the present disclosure. The method can include a step 202 of the driver unlocking the vehicle and occupants entering the vehicle. In this example, the vehicle computer can utilize a face identification feature to scan the driver's face and adjust one or more vehicle settings in response in step 204. In step 206, the driver can start the vehicle, which can include starting the engine of the vehicle. In step 208, the vehicle computer can detect the presence of a known child in the vehicle using any of the methods disclosed herein. In step 210, a drive lock mode is activated to prevent movement of the vehicle once the presence of the known child is determined. In step 212, a request process is executed where permission to disable the drive lock mode is performed using any of the methods disclosed herein. If an authorized user provides a positive response, the method can include a step 214 of disabling the drive lock by the vehicle computer 112.

FIG. 3 is a flowchart of a method of the present disclosure. The method can include a step 302 of determining presence of a known child in a vehicle. This can include, for example, detecting the known child through facial recognition, or detection of a known child computing device. Upon detection of the presence of a known child, a driver may be allowed to start the vehicle, but upon starting the vehicle engine, a drive lock mode is engaged in response to the detection of the known child or known child device. The method can include a step 304 of activating a drive lock mode of the vehicle to prevent the vehicle from being driven based on the presence of the known child. This can include engaging a fuel shutoff, shutting down the vehicle engine, locking the powertrain, or other similar responses to prevent the vehicle from being driven. Next, the method can include a step 306 of providing a request for authorization to allow the vehicle to be driven. As noted above, this can include requesting input from a HMI of the vehicle or a mobile device of an authorized user. The method includes a step 308 of continuing or disabling use of the drive lock mode of the vehicle based upon a response to the request for authorization. For example, when the response indicates that the user is not authenticated and/or authorized, the drive lock mode stays active. If the user is authorized, the drive lock can be deactivated. By way of example, if the request specifies the entry of a code, and the response from the user includes entry of an incorrect code, the drive lock mode remains active.

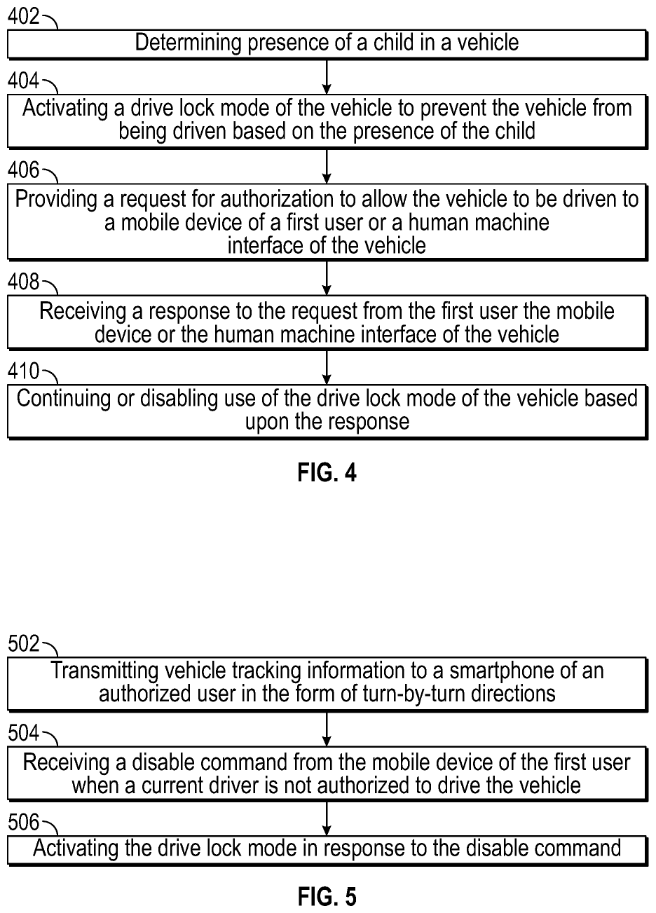

FIG. 4 is another method of the present disclosure. The method can include a step 402 of determining presence of a child in a vehicle. This can include determining the presence of a known child or even the presence of any child. The method can include a step 404 of activating a drive lock mode of the vehicle to prevent the vehicle from being driven based on the presence of the child.

The method can include a step 406 of providing a request for authorization to allow the vehicle to be driven to a mobile device of a first user or a human machine interface of the vehicle, as well as a step 408 of receiving a response to the request from the first user, the mobile device, or the human machine interface of the vehicle. The first user could include an authorized user of the vehicle, such as an owner or another authorized party, such as a designated driver. That is, the first user can disable the drive lock mode of the vehicle to allow the second user to drive the vehicle when the child is present in the vehicle. The method can include a step 410 of continuing or disabling use of the drive lock mode of the vehicle based upon the response.

FIG. 5 is a flowchart of another example method. The method can include a step 502 of transmitting vehicle tracking information to a smartphone of an authorized user in the form of turn-by-turn directions. This can allow the authorized user to track vehicle movement when they are not driving the vehicle or they have granted permission to a designated driver to operate the vehicle with a child present in the vehicle. For example, the vehicle computer can transmit vehicle data such as GPS location information obtained by a telematics control unit.

In instances where the vehicle is driven by a party that is not authorized, such as when the vehicle is stolen, the method can include a step 504 of receiving a disable command from the mobile device of the first user when a current driver is not authorized to drive the vehicle. The method can include a step 506 of activating the drive lock mode in response to the disable command. In addition to placing the vehicle in drive lock mode, the vehicle computer can lock all the doors of the vehicle to prevent the unauthorized driver from leaving the vehicle.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” and the like indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general-purpose or special-purpose computer system. Computer-readable media that stores computer-executable instructions are computer storage media (devices). Computer-readable media that carry computer-executable instructions is transmission media. Thus, by way of example, and not limitation, implementations of the present disclosure can comprise at least two distinctly different kinds of computer-readable media: computer storage media (devices) and transmission media.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characterization have been described, embodiments of the disclosure may relate to numerous other device characterization. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method, comprising:
determining a presence of a known child in a vehicle;
activating, based on the presence of the known child, a drive lock mode of the vehicle to prevent the vehicle from being driven;
providing, based on the vehicle being in the drive lock mode, a request for authorization to allow the vehicle to be driven; and
continuing or disabling, based upon a response to the request for authorization, the drive lock mode of the vehicle.

2. The method according to claim 1, wherein the request for authorization is provided to a mobile device or a human machine interface of the vehicle.

3. The method according to claim 1, wherein determining the presence of the known child comprises:
obtaining images of the known child; and
performing facial recognition on the images to identify the known child.

4. The method according to claim 1, wherein determining the presence of the known child comprises identifying the known child using voice recognition.

5. The method according to claim 1, wherein determining the presence of the known child comprises detecting the known child based on seat sensor data.

6. The method according to claim 1, wherein the drive lock mode comprises:
activation of a fuel cutoff;
engagement of a parking brake;
engagement of one or more door locks;
engagement of an engine lock;
engagement of a powertrain lock; and/or
engagement of a steering wheel lock.

7. The method according to claim 1, wherein the drive lock mode of the vehicle is continued when the response to the request for authorization fails.

8. The method according to claim 1, further comprising tracking movement of the vehicle when the known child is present in the vehicle.

9. The method according to claim 1, further comprising transmitting the movement to a mobile device as turn-by-turn data.

10. A vehicle computer, comprising:
a processor; and
a memory for storing instructions, the processor executing the instructions to:
determine a presence of a known child in a vehicle;
activate, based on the presence of the known child, a drive lock mode of the vehicle to prevent the vehicle from being driven;
provide, based on the vehicle being in the drive lock mode, a request for authorization to allow the vehicle to be driven; and
continue or disable, based upon a response to the request for authorization, the drive lock mode of the vehicle.

11. The vehicle computer according to claim 10, wherein the processor is configured to determine the presence of the known child by detecting the presence of the known child computing device in the vehicle.

12. The vehicle computer according to claim 10, wherein the processor is configured to determine the presence of the known child by:
obtaining images of the known child from an image sensing platform; and
performing facial recognition on the image to identify the known child.

13. The vehicle computer according to claim 10, wherein the processor is configured to determine the presence of the known child by:
detecting the known child using voice recognition; or
measuring seat sensor data that are indicative of a weight of the known child.

14. The vehicle computer according to claim 10, wherein the drive lock mode comprises:
activation of a fuel cutoff;
engagement of a parking brake;
engagement of one or more door locks;
engagement of an engine lock; and/or
engagement of a powertrain lock.

15. The vehicle computer according to claim 10, wherein the processor is configured to:
track movement of the vehicle when the known child is present in the vehicle; and
transmit the movement to a mobile device, the movement being displayed on the mobile device.

16. The vehicle computer according to claim 15, wherein the processor is configured to:
receive a disable command from the mobile device; and
reactivate, based on the disable command, the drive lock mode.

17. A method, comprising:
determining a presence of a known child in a vehicle;
activating a drive lock mode of the vehicle to prevent the vehicle from being driven based on the presence of the known child;
providing a request for authorization to a mobile device or a human machine interface of the vehicle to allow the vehicle to be driven;
receiving a response to the request from the mobile device or the human machine interface of the vehicle; and
continuing or disabling use of the drive lock mode of the vehicle based upon the response.

18. The method according to claim 17, further comprising determining the presence of a second user in the vehicle, wherein the mobile device is configured to disable the drive lock mode of the vehicle to allow the second user to drive the vehicle when the known child is present in the vehicle.

19. The method according to claim 18, further comprising receiving a disable command from the mobile device when the second user is not authorized to drive the vehicle, and activating the drive lock mode in response to the disable command.

20. The method according to claim 18, wherein the drive lock mode comprises activating a fuel cutoff of a fuel system, engaging a parking brake, engaging one or more door locks to lock vehicle doors, engaging a steering wheel lock, engaging an engine lock to prevent engine start, and/or engaging a powertrain lock.
